(19) United States
(12) Patent Application Publication
(10) Pub. No.: US 2025/0148341 A1
(43) Pub. Date: May 8, 2025

(54) OPTIMIZATION TO MITIGATE FREQUENCY CROWDING IN MULTI-QUBIT PROCESSORS

(71) Applicant: International Business Machines Corporation, Armonk, NY (US)

(72) Inventors: Takashi Ido, Bunkyo-ku (JP); NAOKI KANAZAWA, Yokohama (JP); Jared Barney Hertzberg, Yorktown Heights, NY (US); Eric Zhang, Sleepy Hollow, NY (US); Sami Rosenblatt, White Plains, NY (US); Jason S. Orcutt, Katonah, NY (US); Malcolm Scott Carroll, Cranbury, NJ (US)

(21) Appl. No.: 18/501,176

(22) Filed: Nov. 3, 2023

(51) Int. Cl. G06N 10/60; G06F 17/11

(52) U.S. Cl. CPC G06N 10/60; G06F 17/11

(57) ABSTRACT

Define a plurality of qubit collision types and a plurality of constraints. For a group of qubits, use a computerized mixed-integer programming solver to, subject to the constraints, iteratively minimize collisions by minimizing a sum of products of weights multiplied by an amount of frequency collisions for given ones of the constraints of each one of the collision types. Output a frequency tuning plan for the group of qubits, based on the iterative minimization. Facilitate tuning physical qubits in accordance with the frequency tuning plan.

### BACKGROUND

The present invention relates to the electrical, electronic and computer arts, and more specifically, to computer-aided design of quantum computing systems.

A quantum computer exploits quantum mechanics; i.e., the fact that, at small scales, matter exhibits both particle and wave properties. Quantum computers use qubits, analogous to the bit in conventional digital computing.

Qubits can be realized using many modalities. Some common modalities include superconducting qubits based on circuit quantum electrodynamics (cQED) architectures, trapped ion qubits, spin-based qubits, neutral atoms, or photonic qubits. A common modality is superconducting qubits. Superconducting qubit modalities require cooling to cryogenic temperatures, using a cryostat, a dilution refrigerator, or the like. One pertinent example of a superconducting qubit is the fixed-frequency transmon. Quantum computers operate via quantum logic gates between qubits. Such gates may employ, for example, a microwave-activated coupling, a fast tunable coupling, or a parametric coupling between the qubits that form the gate.

A significant challenge for scaling fixed-frequency architectures is mitigating errors arising from lattice frequency collisions. The LASIQ (Laser Annealing of Stochastically Impaired Qubits) technique has been developed to increase collision-free yield of transmon lattices by selectively trimming (i.e., tuning) individual qubit frequencies via laser thermal annealing. Qubits can be addressed by using unique frequencies; however, undesirable collisions may occur, for example, when the frequencies of two nearest neighbor or next-nearest neighbor qubits become too close, or for example, when the frequency spacing between neighboring qubits are within a similar range as the qubit anharmonicity. Other variations of such frequency collisions may occur, and their precise definition will depend on the type of gates used in the quantum processor. Generally, care should be taken in the assignment of such qubit frequencies to ensure avoidance of frequency collision regions, since frequency crowding is a prevalent and industry-wide issue impacting gate fidelities.

### SUMMARY

Principles of the invention provide techniques for optimization to mitigate frequency crowding in multi-qubit processors. In one aspect, an exemplary method includes the steps of defining a plurality of qubit collision types and a plurality of constraints; for a group of qubits, using a computerized mixed-integer programming solver to, subject to the constraints, iteratively minimize collisions by minimizing a sum of products of weights multiplied by an amount of frequency collisions for given ones of the constraints of each one of the collision types; outputting a frequency tuning plan for the group of qubits, based on the iterative minimization; and facilitating tuning physical qubits in accordance with the frequency tuning plan.

Optionally, the method further includes, following the iterative minimization of collisions, for the group of qubits, using the computerized mixed-integer programming solver to iteratively maximize frequency margin, subject to the constraints.

In another aspect, an exemplary computer program product includes a computer readable storage medium having program instructions embodied therewith. The program instructions are executable by a processor to cause the processor to perform a method including: defining a plurality of qubit collision types and a plurality of constraints; for a group of qubits, using a computerized mixed-integer programming solver to, subject to the constraints, iteratively minimize collisions by minimizing a sum of products of weights multiplied by an amount of frequency collisions for given ones of the constraints of each one of the collision types; outputting a frequency tuning plan for the group of qubits, based on the iterative minimization; and facilitating tuning physical qubits in accordance with the frequency tuning plan.

In still another aspect, an exemplary apparatus includes: a memory; and at least one processor, coupled to the memory, and operative to: define a plurality of qubit collision types and a plurality of constraints; for a group of qubits, use a computerized mixed-integer programming solver to, subject to the constraints, iteratively minimize collisions by minimizing a sum of products of weights multiplied by an amount of frequency collisions for given ones of the constraints of each one of the collision types; output a frequency tuning plan for the group of qubits, based on the iterative minimization; and facilitate tuning physical qubits in accordance with the frequency tuning plan.

Optionally, the at least one processor is further operative to control a LASIQ tuning machine to tune a chip in accordance with the plan.

As used herein, “facilitating” an action includes performing the action, making the action easier, helping to carry the action out, or causing the action to be performed. Thus, by way of example and not limitation, instructions executing on one processor might facilitate an action carried out by instructions executing on a LASIQ tool or a remote processor controlling a LASIQ tool, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:

improves the technological process of computer-aided design of quantum computing systems, by improving tuning precision and/or tuning accuracy;

improves the technological process of computer-aided design of quantum computing systems, enhancing tuning yield as compared to prior art systems;

improves the performance of quantum computing systems designed in accordance with exemplary embodiments, by improving tuning precision as compared to prior art systems;

improves the technological process of computer-aided design of quantum systems, by improving the speed of frequency tuning plan generation of multi-qubit and/or modular processors;

significant increase in yield of usable processors and/or modular processors. As used herein, “yield” refers to the fraction of quantum processors, of chips within a modular processor, or of qubits within the chip whose frequencies can be set so as to eliminate frequency collisions and/or to minimize gate error. The yield metric may account for frequency shifts or other random changes expected to occur subsequent to the tuning action. These may be assessed statistically using Monte Carlo models or other known methods of probability or statistical modeling. Usability in the context of quantum processors may be understood to mean benefits in terms of gate speed, gate fidelity, low collision count, or any other metric by which the quality of quantum computation may be improved;

Fewer collisions can lead to a reduced time to run a quantum algorithm and the supporting CPU (classical compute and corresponding energy for the calculation); i.e., savings of CPU time for the computer that runs the design algorithms.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a regularly-spaced rendering of single 127-qubit ‘heavy-hexagon’ fixed-frequency transmon qubit lattice for an exemplary chip that can be tuned in accordance with aspects of the invention;

FIGS. 2-5 shows exemplary sublattices, according to aspects of the invention;

FIGS. 6 and 7 show respectively show collision definitions for a gate error of 1.0% and for a gate error of 0.5%, according to aspects of the invention;

FIGS. 8 and 9 respectively show optimization models for gate error 0.5% to minimize collisions and maximize margin, according to aspects of the invention;

FIG. 10 shows an exemplary workflow of frequency tuning planning, according to aspects of the invention;

FIG. 11 shows exemplary tuning plan generation, according to aspects of the invention;

FIG. 12 shows an exemplary process of feedback for in-situ yield improvement by regenerating new tuning plans as the tuning progresses, according to aspects of the invention;

FIG. 13 depicts iterative tuning rounds, according to aspects of the invention;

FIG. 14 depicts exemplary yield assessment, according to aspects of the invention;

FIGS. 15-18 show exemplary results for LASIQ tuning to an optimized plan, according to aspects of the invention;

FIG. 19 depicts a computing environment according to an embodiment of the present invention.

### DETAILED DESCRIPTION

LASIQ tuning is a process of progressive alteration of the resistances of Josephson junctions. To this end, any quantum element including one or more Josephson junctions may be tuned using LASIQ. For example, a fixed-frequency transmon qubit includes a Josephson junction shunted by a capacitor, whereby the Josephson junction behaves as a nonlinear inductor element that allows the qubit to exhibit non-uniform energy spacing between successive energy levels (i.e., the qubit exhibits anharmonicity which allows uniquely addressable ground and first excited states). By performing LASIQ on these fixed-frequency transmon qubits, the Josephson junction resistances, and correspondingly the transmon qubit frequencies, may be modified post-fabrication. In this context, LASIQ may therefore be used as a post-fabrication frequency trimming tool to engineer qubit frequencies to desired frequency patterns.

Lattices of fixed-frequency transmon qubits are typically fabricated in a specific lattice geometry (for example, a heavy-hexagonal lattice, square lattice, or the like). Furthermore, qubits are known to suffer from frequency crowding, which arises from energy level degeneracies between neighboring and next-nearest-neighboring qubits, and even higher order connectivity may be considered. This frequency crowding may be quantified by the number of collisions that the multi-qubit lattice exhibits. Each collision type may be defined by frequency bounds within which qubit pairs, or triplets are forbidden to enter. Other undesired neighboring, next-nearest neighboring, or further neighboring interactions may be enumerated and frequency bounds may be similarly defined as desired. If these bounds are trespassed, high gate errors, and therefore low gate fidelities will be observed. LASIQ is a laser-annealing methodology that may be used to iteratively tune the Josephson junction resistances using a sequence of annealing ‘pulses,’ to gradually and monotonically approach their respective target resistances, thereby engineering the qubit frequencies into desired values, levels, patterns, or the like.

The term ‘pulse’ as used herein denotes a laser anneal operation that is performed by applying laser power to a target element (e.g., Josephson junction) for a specified duration (anneal time) to tune the target element. In the context of exemplary embodiments of the disclosure as discussed herein, laser tuning methods are provided to tune junction resistances of Josephson junctions in a progressive and incremental manner wherein multiple ‘pulses’ are applied to a given Josephson junction to tune the junction resistance of the Josephson junction to a target junction resistance.

The term “annealing iteration” used herein and in the context of a laser annealing process is meant to refer to the process which comprises a single laser pulse along with associated control, measurement and computation by the LASIQ computer system and apparatus to determine the necessary anneal time and power for the anneal pulse. A laser annealing iteration, or LASIQ iteration, therefore, refers to the entire process by which a Josephson junction is measured, the anneal power and time is determined, and the anneal pulse is performed. In this sense, one iteration involves the entire sequence of the laser annealing system and apparatus as it pertains to one step of the progressive approach to the resistance target for one Josephson junction. The tuning of one junction to completion (i.e., reaching its resistance target) may therefore be said to progress “iteratively.” The term “iterative process” as used herein, is meant to generally refer to a set of iterations, as applicable to one or more qubit devices, or the like, including Josephson junctions, whereby the one or more qubit devices are tuned with the purpose of approaching their respective targets.

The term ‘round-robin’ or ‘annealing round’ as used herein and in the context of a laser annealing process, is meant to refer to a tuning process in which all qubits on a multi-qubit device undergo the laser annealing process in succession, and which may be followed by another round-robin or multiple round-robins in succession. Such round-robins may be continuously performed until all qubits on the multi-qubit device reach their respective targets. For example, a singulated quantum chip may include a number of qubit devices (e.g., 100 qubits, denoted Q1, Q2, Q3, . . . , Q100) including Josephson junctions. In an exemplary embodiment of a tuning method, Q1 will first be tuned with one or more annealing iterations, as desired. The process will proceed to Q2, where one or more annealing iterations may be performed, as desired. The process will then proceed to Q3, etc. until finally Q100 is tuned with one or more annealing iterations, as desired. This entire process from Q1 to Q100 is defined as one round-robin. After this first round-robin, the process may return to Q1, and will repeat again until Q100 is reached. The process of successive round-robins may provide time control and delay between iterations or sets of iterations, such that the Josephson junctions may be permitted to relax to their final resistances prior to the next annealing iteration or set of iterations.

The term “optimization iteration” as used herein and in the context of a frequency plan generated by an optimization routine, is meant to refer to the process by which an optimization routine based on a mixed integer programming routine is used to solve for a frequency pattern across the lattice that assigns each qubit in the lattice an operating frequency which is intended to mitigate collisions with nearest-neighbor, next-nearest-neighbor, or any other n-degree neighboring qubit, with the goal of maximizing single and multi-qubit gate fidelities. During each optimization iteration, a frequency plan is generated for the entire lattice once, by tiling the multi-qubit lattice using a series of sublattices which may include overlapping qubits with neighboring sub-lattice tiles. Note, many of the sublattices will typically be identical; however, some sub-lattices are typically not identical, for example, around the corner of a heavy-hexagonal lattice (sub-lattices around the corner may not have full qubits consisting of H-shape or cycle-shape). Upon completion of a given optimization iteration, another iteration may subsequently be implemented to remove residual collisions. Therefore, during the process of successive optimization iterations, an increasingly improved solution, yielding successively lower collision counts, may be achieved, and a desired number of optimization iterations may be specified by an operator skilled in the art (e.g., heuristically, given the teachings herein), or may be automated using yield metrics that specify, for example, a target gate-fidelity which the solution must exceed to be accepted, and for the LASIQ tuning process to subsequently commence.

During LASIQ tuning, the frequencies typically monotonically and iteratively approach the target, where the resistance targets, or equivalently, frequency targets are determined through a frequency tuning plan generator. The iterative approach to target is based on successive laser ‘pulses’ that asymptotically move the qubit frequencies to a target frequency. The asymptotic and gradual tuning approach reduces the risk of overshooting or undershooting the junction resistances. To ensure this progressive approach to target, various calibration structures may be utilized towards determining the typical tuning rate and tuning range of the Josephson junctions, using dedicated test structures that may be interleaved and/or situated on unused locations of the chip (for example, the ‘kerf’ of a chip, which is an unused location that physically separates two adjacent dies on a wafer, or coupon), or using a ‘sister’ chip, which has undergone the same process steps during fabrication. However, despite the care taken to avoid overshooting or undershooting, the statistical likelihood of such anomalies increases and is practically unavoidable as quantum chips scale to the hundreds, or thousands of qubit scales and greater. In other words, given the large scales of modern quantum processors, it is essentially impossible for all qubits to successfully achieve their target frequencies as designed in an initial tuning plan. This is detrimental to chip yield (for example, as assessed by the collision-free probability), which results in the chip being discarded (e.g., due to the anticipated high gate-error rates). The net effect involves significant reduction in the resulting number of usable processors, given a batch of chips that are to be tuned. One or more embodiments provide techniques for in-situ and adaptive target modification to be able to correct for these tuning errors and imperfections to increase the yield of quantum processors.

Yield metrics of quantum processor(s) may be assessed through both deterministic and statistical analysis, or the like. For example, one yield metric commonly used may include the number of collisions in an as-tuned chip, or a comparison of collision numbers before and after LASIQ tuning. However, more sophisticated methods may be implemented to determine the expected number of collisions that may be obtained after completion and cooling of a quantum processor in a cryostat. Such methods apply to single-chip processors and both within and across each chip of a modular device. This may be accomplished, for example, using a Monte Carlo method, or the like, by which the predicted frequencies undergo a random scatter with a magnitude defined by a frequency precision interval (e.g., 20 MHz), and the impact of the scatter of the expected number of collisions is quantitatively assessed. Equivalently, it is possible to calculate the expected probability of a zero-collision chip on a non-modular or modular device. Another metric that may be used is predictions of gate error rates, gate fidelity, and/or gate speed. Such models may take into account, for example, qubit coherence times in addition to qubit frequencies after LASIQ tuning. Such models are architecture dependent. However, one or more embodiments for adaptive and in-situ modifications of such tuning plans are not limited to any specific method of tuning plan generation or multi-qubit architecture, but rather, given a known architecture of lattices and qubit coupling mechanisms and acceptable yield metrics, one or more embodiments may be implemented to generally and significantly improve the fraction of acceptable chips. Once a multi-qubit chip has been successfully tuned, such yield metrics may be employed to select the desired candidate for further cryogenic screening, whereby the multi-qubit processor may be cooled to cryogenic temperatures and further characterized, for example, by measuring the qubit frequencies and comparing them to predicted frequency targets, quantifying qubit coherence, measuring single and multi-qubit gate fidelities, and the like.

As noted above, the LASIQ (Laser Annealing of Stochastically Impaired Qubits) technique has been developed to increase collision-free yield of transmon lattices by selectively trimming (i.e., tuning) individual qubit frequencies via laser thermal annealing. LASIQ tuning can be used in one or more exemplary embodiments. However, it is to be understood that embodiments described herein requiring frequency tuning (e.g., of functional qubits, quantum logic structures, quantum coupling structures, or any general elements that include one or more Josephson junctions) are not limited solely to the use of LASIQ tuning, but rather, any frequency tuning capability of qubits and/or elements based on Josephson junctions may be utilized to satisfy the frequency tuning requirements needed to successfully implement a quantum device including one or more interconnected processors, as may occur in a modular device (i.e., various embodiments are applicable to both modular and non-modular systems). In one exemplary embodiment, a LASIQ tool is used to perform laser-annealing of Josephson junctions of fixed-frequency transmon qubits, which are connected in a heavy-hexagonal lattice, whereby nearest and next-nearest neighboring collisions are considered.

Microwave-tunable superconducting qubit architectures, for example, flux-tunable architectures, can be employed in some instances. In one or more embodiments, significant gain in yield may be obtained using techniques to selectively trim frequencies of individual qubits and various elements based on Josephson junctions, that may be part of microwave-tunable superconducting qubit architectures.

Frequency tunability via laser annealing (e.g., the LASIQ process) may be assessed, for example, using the calibration methodology described elsewhere herein, by which a set of trial junctions are laser-annealed to determine the tuning rate and tuning range, and any other functional parameter deemed necessary to tune junctions to completion. In particular, in one or more embodiments, tuning rates are used to estimate the laser annealing duration required to substantially tune a junction to completion, and the tuning range (i.e., maximum tuning limit) is used to constrain the generation of the tuning plan for qubit frequencies (as used herein, “substantially tune a junction to completion” means the tuning needed to tune a junction to a target completion band, which could be, in a non-limiting example as discussed elsewhere herein, 0.3% of the target resistance. The 0.3% figure is exemplary and can be modified as needed by the skilled person based on heuristics depending on the domain of interest and application). As an example, a tuning plan may include a fixed multitude of frequency levels, and each qubit should reside on one of these levels, and also be tunable to these levels. The latter condition is determined by calibration of similar junctions, whereby these similar junctions are tuned to observe how far their resistances may be shifted. By appropriate assignment of each qubit to a frequency level, and within tunability constraints, it is possible to avoid level degeneracies that may cause unwanted crosstalk (i.e., collisions) and therefore low gate fidelity. Other examples of methods by which a tuning plan is generated can include a fixed frequency plan, or an optimization protocol by which each qubit may reside within a range of frequencies, whereby this range (constrained by collision bounds) is subject to the frequency value of neighboring or next-nearest neighboring qubits. The mentioned exemplary methods for generating tuning plans are not intended to be exhaustive, but rather serve as illustrative examples of methods by which tuning plans can be generated given a lattice topology, as is the case in lattices of superconducting qubits. In general, any other tuning plan generators which adequately mitigate frequency collisions would be considered acceptable, as will be apparent to the skilled artisan given the teachings herein. Such tuning plans outside the scope of fixed-frequency patterns and optimization protocols are referred to herein as “ad-hoc” plans. Described herein are optimization protocols to generate frequency tuning plans for multi-qubit processors, whereby an optimization routine based on a mixed-integer programming problem is shown to generate tuning plans that may successfully mitigate frequency collisions. However, the adaptive methods described herein are not limited by any specific method of tuning plan generation, but may be generally applicable to any frequency tuning plan generator, whether ad-hoc, or the like.

Frequency collision analysis and collision-free yield may be an important metric to consider when determining the yield of a tuned chip. Collision bounds for a given quantum processor architecture may be derived using known empirical and/or first-principles gate error models for the superconducting qubit architecture being tuned. As an illustrative embodiment, a fixed-frequency transmon qubit pair can be modeled as undergoing ZX interaction which is used to realize a CNOT (controlled NOT) gate. High-fidelity gates typically require this interaction to be controlled by assigning appropriate bounds to the relative frequency difference between nearest- and next-nearest neighboring transmon qubits pairs. Gate error modeling should therefore account for this interaction while accounting for various sources of noise; for example, that arising from static ZZ interactions among qubits. In one or more exemplary methods, the gate error modeling, and therefore frequency collision bounds, may be performed by empirically measuring the frequencies of devices and the corresponding gate fidelities that may be achieved on the given architecture.

The skilled artisan, given the teachings herein, can adapt known tuning plan generators to implement one or more embodiments. Nominally, junction resistances increase, and therefore qubit frequencies decrease upon tuning. Therefore, for example, if a qubit or group of qubits undershot in resistance (i.e. reached their tuning limits before they could reach target), one or more embodiments generate a new tuning plan subject to the constraint that the undershot qubits should not be moved any more, since there is no more tuning range left in those qubits. On the other hand, if, for example, a qubit or group of qubits overshot, one or more embodiments generate a plan that allows them to continue tuning if they have not yet reached their estimated maximum range. In some embodiments, qubits tune bi-directionally. In this aspect, they can be tuned both up and down as needed, within the tuning range limits. The nature and directionality of tuning may be determined based on the calibration trial junctions, which will be subjected to laser annealing at various combination of laser power and time.

It is currently envisioned that a future quantum computer (>1000 qubits in the Condor processor), utilizing cross-resonance technology from International Business Machines Corporation (IBM), Armonk, NY, USA, will make use of fixed-frequency transmon qubits, which require post-fabrication frequency trimming using LASIQ. We have found, using modeling, collision zones that should be avoided to ensure high gate fidelity (7 collision types), and that, ideally, fixed frequency patterns (e.g., 3-frequency (3f) patterns) will help to effectively avoid all collision types. As fabricated, there may be a large initial tuning spread on the qubits (up to 5% in resistance, which corresponds to >200 megahertz in frequency spread). With such a large spread, it is not feasible to control the number of collisions in an as-fabricated multi-qubit processor. The LASIQ process can be used to control this to a frequency precision of about 20 megahertz, providing an order of magnitude improvement in frequency control. However, due to limited tuning range (˜15% in resistance), it is generally not possible to attain an ideal 3f pattern using current laser annealing techniques. One or more embodiments described herein mitigate frequency crowding. One or more embodiments advantageously provide an alternative frequency plan generator that can work within the constraints of tuning range and collision boundaries to generate an adequate tuning plan for a given processor before it enters the LASIQ process. Such constraints may, for example, include tuning range limits such that the alternative frequency plans may satisfy yield requirements.

One or more embodiments provide techniques to generate frequency tuning plans for lattices of fixed-frequency transmon qubits, based on an optimization routine, which treats the tuning plan generation as a mixed-integer programming problem, with constraints of collision bounds and the goal of minimizing the total number of collisions, as defined by an objective function. Mixed-integer programming problems are not generally solvable in polynomial time, and solving a full heavy-hexagonal lattice (e.g., IBM's Eagle 127 qubit system, or for example, IBM's 433 qubit Osprey system) can be prohibitively slow. At scales of 1,121 qubits (e.g., IBM's Condor system), this optimization is essentially impractical, with formidable computational resources required to adequately solve the optimization problem.

One or more embodiments overcome these issues and demonstrate computational efficiency by using a ‘tiling solution’ where the lattice is divided into unit-cell sub-lattices, then each sub-lattice is optimized, and then the boundary collisions between tiles are resolved in subsequent iterations. One or more embodiments weight the significance of collisions by either increasing or decreasing collision bounds (or equivalently, frequency avoidance regimes), or by changing their relative importance in the objective function. In one or more embodiments, the tuning plan configuration can be changed by changing the tuning range. We have found that this tuning plan generator can be used to tune a 127 qubit scale processor, and that the yield metrics quantified on the resulting post-LASIQ tuned processor is close to the desired tuning plan. Our results demonstrate the efficacy of LASIQ tuning a 127 qubit scale processor using tuning plans generated by our computationally efficient optimization routine. Different embodiments can use different tiling schemes. In some embodiments, the full lattice can be solved without tiling, using large compute resources. In some embodiments, the tuning plan can be used repeatedly during LASIQ to compensate for tuning imperfections.

Examples are provided herein for heavy-hexagonal lattices but aspects of the invention can be used for lattices of any connectivity, including modularly connected multi-qubit processors, where elements on the multi-qubit and modular processors include functional qubits, quantum logic structures, quantum coupling structures, or any general elements that include one or more Josephson junctions. In general, the LASIQ tuning process may be used to frequency control any structure including Josephson junctions whose tunnel-barrier is susceptible to tuning by laser-annealing. Such structures may include qubits of various kinds, or SQUIDs (superconducting quantum interference devices), or single Josephson junctions, or other combinations of Josephson junctions, capacitors and inductors. They may be galvanically, inductively, or capacitively linked with neighboring structures on-chip. The functional structures may contain Josephson junctions that are of different design or construction as compared to the Josephson junctions in the quantum coupling structures. The several types of Josephson junctions typically undergo calibration to determine their response to laser-power and exposure time. These separate calibrations determine the tuning range and tuning rates specific to the functional structures and to the quantum coupling structures. In general, given frequency constraints (i.e., collision bounds) and tuning constraints (e.g., tuning range), a suitable objective function and lattice tiling may be defined to enable a computationally efficient optimization routine.

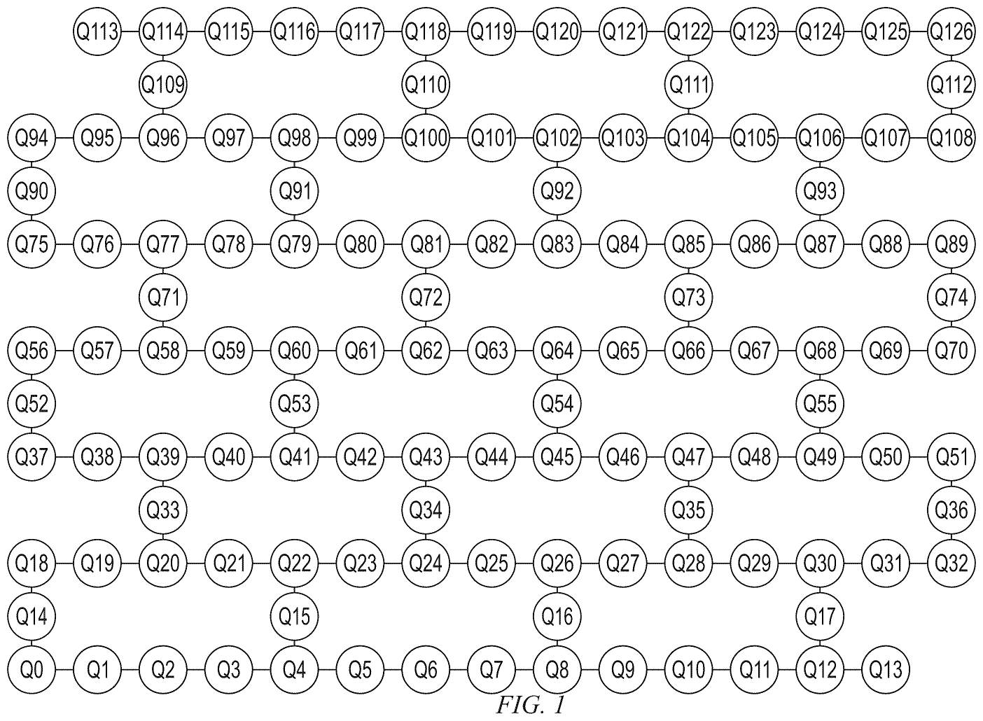

FIG. 1 shows a regularly-spaced rendering of single 127-qubit ‘heavy hexagon’ fixed-frequency transmon qubit lattice for an exemplary chip (i.e., the IBM ‘Eagle’ quantum processor). Other lattice geometries are possible. One or more embodiments seek to mitigate ‘collisions’ and assign nearest-neighbor and next-nearest neighbor qubit frequency detuning to low gate error regimes; for example, in lattices of fixed-frequency qubits with 7 collision types. Advantageously, at least some embodiments use an ideal 3-frequency pattern to avoid all 7 collision types. However, achieving such an ideal 3-frequency pattern can be challenging given tuning range constraints (typically 15% resistance), and as-fabricated spread (4-5% resistance). In such a case where ideal 3-frequency patterns are not attainable due to tuning range constraints, one or more embodiments can utilize computationally efficient optimization methods described herein, by using a sub-lattice tiling scheme whereby subsets of the larger lattice may be sequentially solved, and ‘tiled’ across the larger lattice to obtain a holistic solution. In this manner, a computationally hard problem may be converted to one which scales linearly with lattice size, thereby significantly increasing the throughput of the optimization routine and permitting real-time adaptive solutions during the LASIQ tuning process. Such adaptive solutions advantageously accommodate cases where overshoot or undershoot of individual qubits may occur, and new plans must be generated in situ to avoid excess collisions and therefore low gate-fidelities.

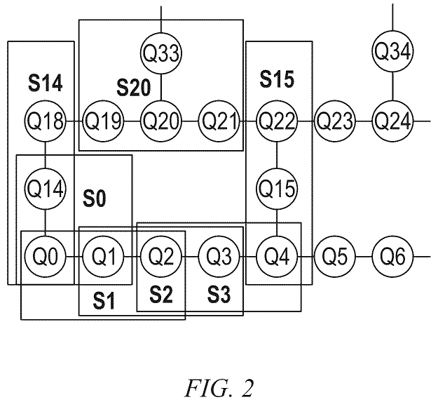

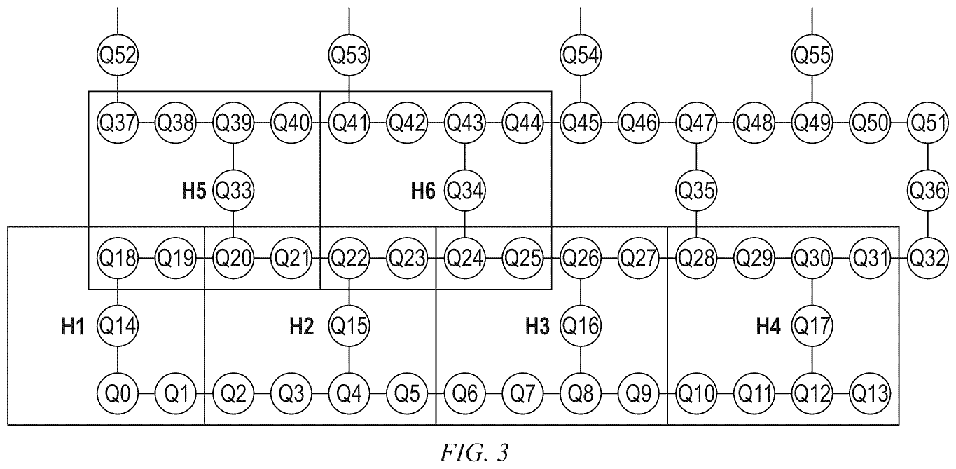

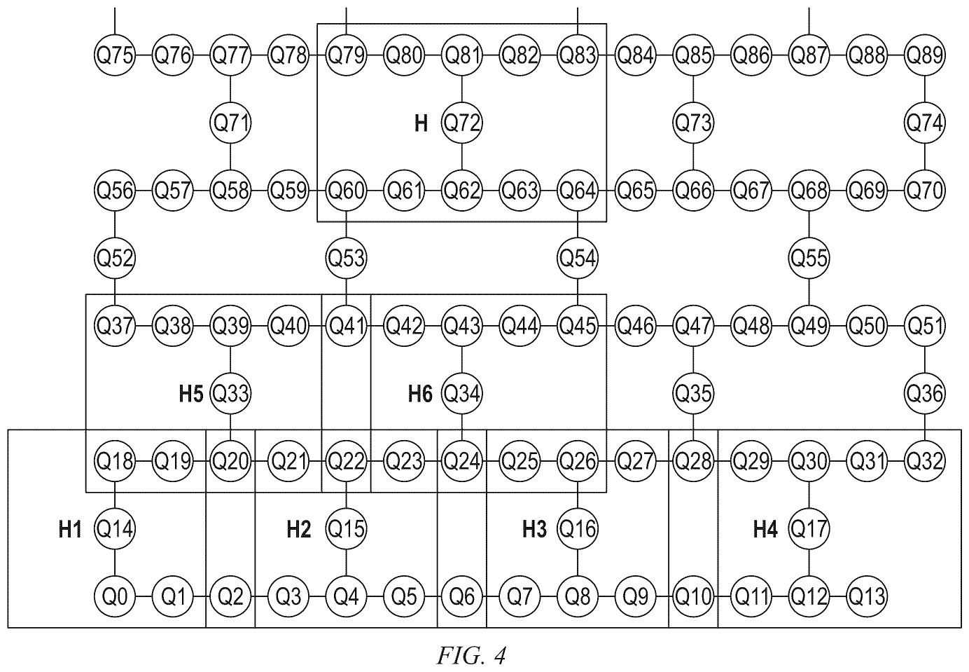

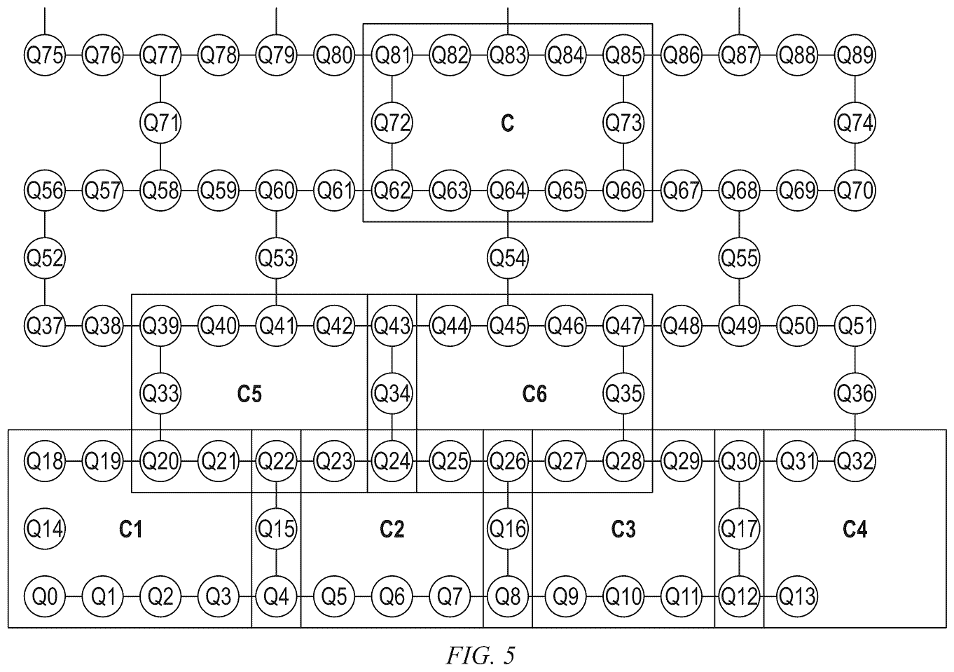

Consider now sub-lattice tiling in accordance with aspects of the invention. One or more embodiments optimize frequency plans by dividing the entire qubit lattice into a set of small sub-lattices such that each qubit is covered by at least one sub-lattice (sub-lattices can overlap each other), and optimizing the frequency plans for all sub-lattices separately. As shown in FIGS. 2-5, a number of different variations of sub-lattice shapes are possible. In an “Each qubit” sub-lattice approach, shown in FIG. 2, enumerate each qubit (called a target qubit) and let a set of qubits including the target qubit and its neighboring qubits be a sub-lattice. This “Each qubit” approach is qubit layout agnostic, as it can be employed in any general lattice layout regardless of the degree of connectivity. In the sub-lattice of each qubit in FIG. 2, SO includes Q0 and its neighboring qubits (Q1 and Q14). Also consider tiling schemes in FIGS. 3-5 that are specific to the heavy-hexagonal lattice as depicted in FIG. 1. For example, an “H-shape” sub-lattice of 9 (FIG. 3) or 11 (FIG. 4) qubits, where the sub-lattice respectively includes a pair of 4- or 5-qubit lines and an in-between qubit. Still another possibility is a “Cycle” sub-lattice of 12 qubits as shown in FIG. 5: a sub-lattice of a cycle of 12 qubits. The specific embodiments of sub-lattice tiling enumerated in FIGS. 3-5 are only possible in a heavy-hexagonal lattice due to the degree-2 and degree-3 connectivity required for tiling the “H-shape” or “Cycle” sub-lattice. Note that one or more embodiments use a subset of the sub-lattice shape around the corner of the qubit lattice, and that in FIGS. 2-5, only part of sub-lattices are drawn. In other embodiments where multi-qubit lattices other than the heavy-hexagonal are used, it is to be understood that methods described herein can be applied by using any sub-lattice tiling scheme whereby the full lattice can be tiled with overlapping qubits in neighboring sub-lattices. The optimization method used herein can minimize collisions in each sublattice, while accounting for the overlapping qubit frequency assignments in the neighboring sub-lattice tiles. Once all sublattices are thus optimized, the optimization method can repeat the process across the entire lattice a specified number of times to remove residual collisions that were created during the tiling process.

In an exemplary workflow, set an initial guess of the frequency plan (e.g., using the lower or upper bound of tuning range/frequency shift, or by randomly picking a number in the range); repeat (iterate) several times to optimize the frequency plans of all sub-lattices. Note that an optimization iteration, as previously described, optimizes all sub-lattices once. The optimization of each sub-lattice can be done sequentially or in parallel. In one or more embodiments, specify the number of optimization iterations as an input parameter “num_repetitions” which represents how many times the lattice solution repeated across all sub-lattice tiles. In a non-limiting exemplary embodiment, utilize two optimization iterations, where in the first optimization iteration, all sub-lattice tiles are solved, and in the subsequent (i.e., second) optimization iteration, the solver is repeated across all sub-lattices to minimize residual collision. One or more embodiments can use one sub-lattice tiling scheme (e.g., an “H-shape” sub-lattice). In other embodiments, different tiling solutions may be implemented on successive optimization iterations. One or more embodiments employ mixed-integer programming models to optimize a frequency plan of a sub-lattice.

One or more embodiments can thus employ a variety of sub-lattice variations. The “H” options in FIGS. 3 and 4 essentially have an H-shape rotated 90 degrees. In one or more instances, divide the entire lattice into sublattices, with the constraint that every qubit should be covered by at least one sublattice. In the 11 qubit case of FIGS. 4, H5 and H6 overlap so several qubits are covered by more than one sublattice. On the other hand, in the 9 qubit case of FIGS. 3, H5 and H6 do not overlap with each other. The “H-shape” configurations of FIGS. 3 and 4, and the cycle sublattice configuration of FIG. 5, are focused on the heavy-hexagonal lattice. The “Each qubit” sublattice which includes a three-qubit or four-qubit sub-lattice for each individual target qubit of FIG. 2 is more generalizable to different types of lattices, each target qubit will in general have two or more nearest-neighbors. Each sub-lattice in FIG. 2 therefore includes the target qubit and its neighbors, and each qubit is covered by at least its own sublattice. Different tiling shapes can be mixed (e.g., any of FIGS. 2-5), subject to the constraint that each qubit is covered by at least one sublattice.

One or more embodiments use the IBM® ILOG® CPLEX® Optimizer (registered marks of International Business Machines Corporation, Armonk, New York, USA) to solve the optimization models. Given the teachings herein, the skilled artisan will be able to implement embodiments using other mixed-integer programming solvers such as the Gurobi product available from GUROBI OPTIMIZATION, LLC, Beaverton, Oregon, USA, and the FICO® Xpress Optimization product available from FICO, Bozeman, MT, USA. In general, any solver capable of implementing mixed-integer programming solvers may be used to perform optimization iterations and are not limited to any solvers listed herein.

Consider now objective functions and constraints, and how to identify a frequency tuning plan for each sublattice. In one or more instances, there are several frequencies for each qubit. In one or more embodiments, inputs include:

the entire qubit lattice and target sub-lattice

f_{i,01} (frequency of |0>→|1> corresponding to the qubit transition frequency) and anhᵢ (anharmonicity) for each qubit i of the entire lattice (f₁₂=f₀₁+anh, or equivalently, f₀₂=2*f₀₁+anh, or f₀₂/2=f₀₁+anh/2)

frequency plan (f′_{i,01}) of the outside of the target sub-lattice

assume default cross resonance direction: control j and target k if f_{j,01}>f_{k,01}.

In one or more embodiments, decision variables include:

sᵢ: frequency shift of qubit i in the target sub-lattice. In this regard, let f′_{i,01}=f_{i,01}+sᵢ be the frequency of qubit i after shift. f′_{i,12}, f′_{i,02}, f′_{i,02/2} are defined in a similar way. Further, f′_{i,01} of the outside of the sub-lattice is given as the input and treated as a constant.

ε: margin to the collision boundary.

r_{j,k}: 0 if the default control and target direction is used, 1 if the opposite direction is used.

z_{i,n}: amount of frequency collision of n-th constraint of collision type i in the sublattice.

Pertinent parameters include:

ε^{lb}: minimum margin ε

sᵢ^{lb}, sᵢ^{ub}: lower bound and upper bound of frequency shift sᵢ of qubit i

wᵢ: weight of collision type (i=1, . . . ,7)

bᵢ: scaling factor of collision bound (i=1, . . . ,7).

Possible objective functions include:

Minimizing the sum Σ_{i,n} wᵢz_{i,n} of (weighted) frequency collisions

Maximizing the margin ε if there is no collision.

Thus, based on f_{i,01} (frequency of moving from ground state zero to first excited state 1) and anhᵢ (anharmonicity) for each qubit, i, of the entire lattice, other frequencies can be computed, such as f₁₂=f₀₁+anh, f₀₂=2*f₀₁+anh, f_{02/2}=f₀₁+anh/2, which are needed to determine whether nearest-neighbor or next-nearest-neighboring collisions exist. In one or more embodiments, these quantities are utilized for the definition of the collisions and the optimization model computes them during the optimization. Assume, in one or more embodiments, that the frequency plan outside of the target sublattice is fixed. In the example, subscript j refers to control and subscript k refers to target. One or more embodiments maximize the margin ε if there is no collision. In an exemplary embodiment, the margin ε is maximized to the collision boundary for maximum efficacy of collision mitigation.

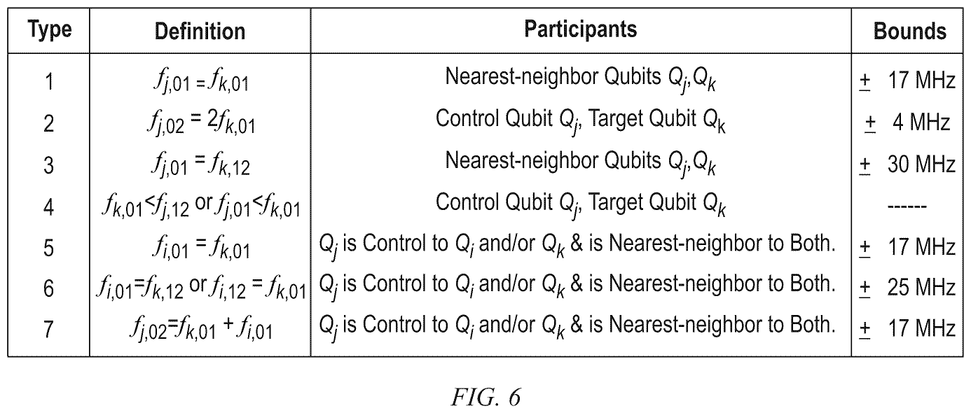

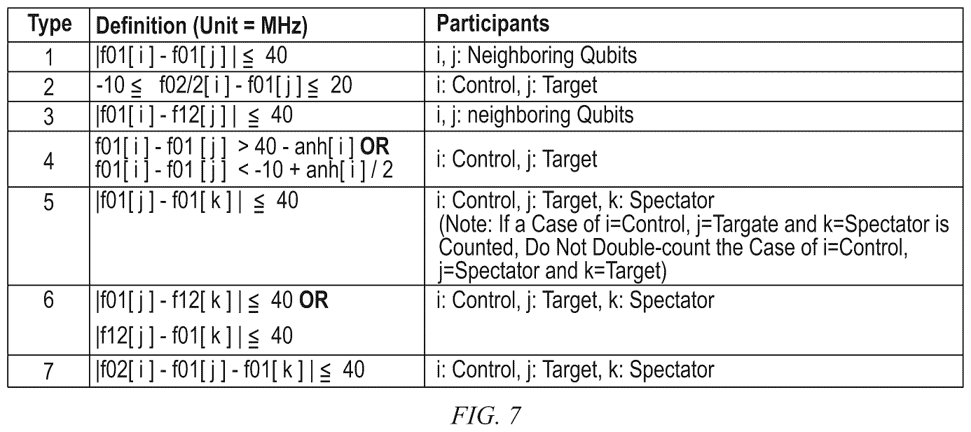

Referring now to FIGS. 6 and 7, in one or more embodiments, constraints include avoiding all 7 frequency collision types. This list of nearest-neighbor and next-nearest-neighbor collisions pertains to lattices of fixed-frequency transmon qubits; however, other embodiments with different multi-qubit lattices geometries and qubit architectures may include a subset or superset of this list of collisions. The optimization iterations described herein may therefore be equally implemented to various types of lattice geometries and qubit architectures, by defining corresponding collision constraints and bounds.

Generally, frequency collision types and bounds will now be considered. We have found that in one or more embodiments, there are 7 types of collisions, with the definition depending on the target gate error. The table of FIG. 6 shows the definition for a gate error of 1.0%. The table of FIG. 7 shows the definition for a gate error of 0.5%, with the collision bounds correspondingly increased for each collision type. Generally, a constraint to avoid collision can be represented as a linear constraint or indicator constraint. One or more embodiments control the importance of collision type by weight wᵢ and scaling factor bᵢ. The weight wᵢ is multiplied with the amount of collisions of type i in the objective function. A large weight wᵢ will increase the relative importance of collision type i. The scaling factor bᵢ is multiplied with the bound of collision type i. For example, to achieve 0.5% gate error, for example, b₁=1 is implemented to use the collision bounds exactly as listed in FIG. 7. To increase the bound of type-1 collision (and therefore obtain a solution that mitigates type-1 collisions beyond the 0.5% gate error bound), b₁=2.0 results in 40*2.0=80 MHz bound.

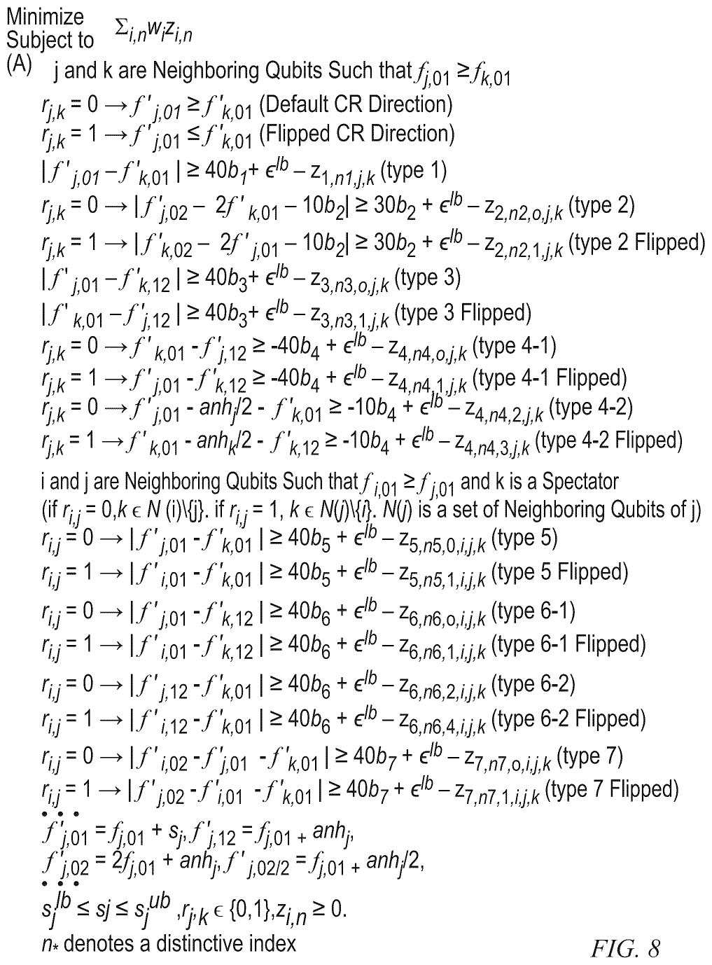

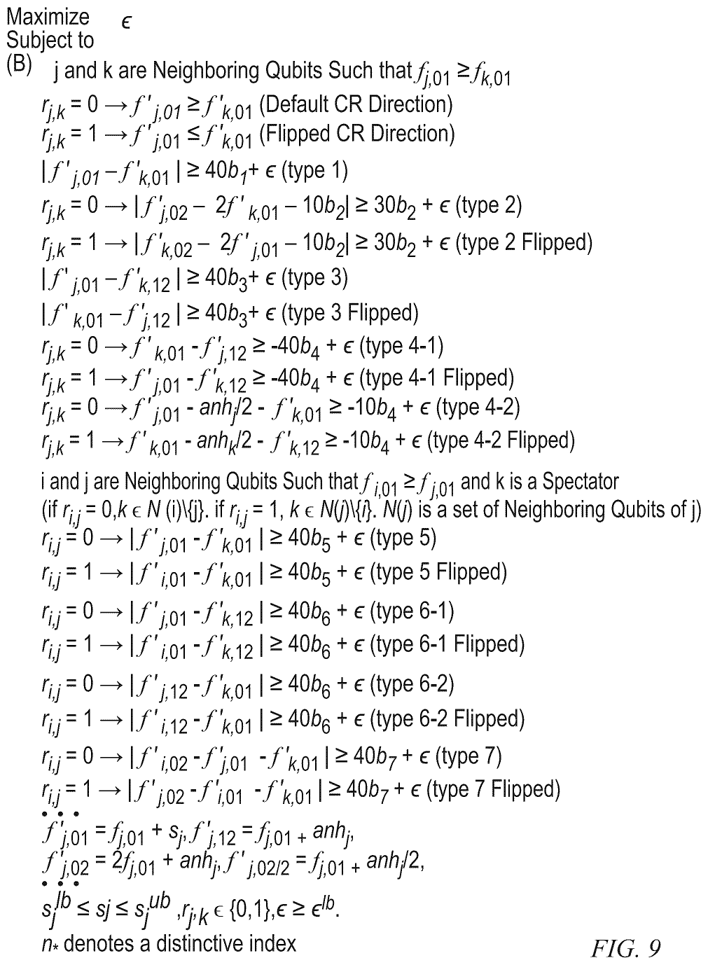

Refer now to FIGS. 8 and 9 for optimization models for gate error 0.5% to minimize collisions (example A FIG. 8) and maximize margin (example B FIG. 9). As will be appreciated by the skilled artisan, given the teachings herein, optimization models for any gate error and any number of collisions for a given lattice connectivity can be formulated in a similar way. Note that the optimization models consider constraints involving one or more qubits in the target sub-lattice. One or more embodiments apply a mixed-integer programming solver to optimize the model A (FIG. 8) and model B (FIG. 9). Some solvers such as CPLEX can directly handle indicator constraints (r_{j,k}=0→ . . . ) and absolute value functions (|f . . . |). Indicator constraints and absolute value functions can be translated into linear constraints in case of using solvers that cannot handle them directly. One or more embodiments provide a workflow to optimize the frequency plan of a target sub-lattice. Assume that frequencies outside the target sub-lattice are constant. Solve model A (FIG. 8), using a specified number of optimization iterations. If the final solution has some collisions, then return the frequency plan. If the solution has no collision, model B may (FIG. 9) be additionally solved to further mitigate collisions and return the frequency plan. In some instances, model B (FIG. 9) can be omitted as an option; users can expect faster runtime by omitting model B (FIG. 9). Note, regarding indicator constraints, if variable r_{j,k}=0, then some particular constraint should be satisfied. An indicator constraint “variable_x=constant_c→constraint_y” means that “if variable_x is constant_c then constraint_y is satisfied”. For example, model A has a constraint “r_{j,k}=0→f′_{j,01}≥f′_{k,01} (default CR direction)” means that “if r_{j,k} is 0, constraint f′_{j,01}≥f′_{k,01} should be satisfied. Otherwise, the constraint is not necessarily satisfied.

Model A (FIG. 8) defines the objective function Σ_{i,n}wᵢz_{i,n} which is to be minimized subject to the conditions defined in the subsequent definitions and inequalities. For example, avoidance of type-1 collisions entails the condition |f′_{j,01}−f′_{k,01}|≥40b₁+ε^{lb}−z_{1,n}_{_{1,j,k}} where j and k are neighboring qubits such that f_{j,01}≥f_{k,01}, while f′_{j,01}=f_{j,01}+sⱼ and f′_{k,01}=f_{k,01}+anhⱼ are the tuned qubits i and j. As defined, the bounds for type-1 collisions are given by 40 MHz, while the multiplicative scaling b₁ provides additional bounds beyond the 0.5% gate error bounds defined in FIG. 7. The term z_{1,n}_{_{1,j,k}} effectively quantifies the contribution to the type-1 collision. In conjunction with the objective function above, the contribution can be weighted by the weighting function wᵢ, which can be altered to emphasize or de-emphasize the significance of the type-1 collision contribution z_{1,n}_{_{1,j,k}} in the objective function. In a similar manner, define corresponding z_{1,n} contributions to the objective function for each collision type, including accounting for 3-neighbor collisions (spectator collisions), enumerated by type 5-7. Model A can be solved using a tiling solution over a number of optimization iterations and a tuning frequency plan may be thus generated.

Subsequent to generating a frequency plan using model A, the resulting residual collisions may be assessed, and if deemed practical a further model B (FIG. 9) can be implemented. In an exemplary embodiment, model B (FIG. 9) can be run, for example, in the case where the result of model A produces a collision-free frequency solution, in which case model B will maximize the margins (i.e., distance of relative qubit detuning between nearest-neighbor and next-nearest-neighbor) to the collision frequency bounds, thus minimizing the statistical likelihood of a collision arising after the LASIQ tuning process. In a manner similar to model A (FIG. 8), model B (FIG. 9) can be run by introducing sub-lattice tiling and repeating the solution over a number of optimization iterations to ensure an acceptable solution is obtained. In this manner, by implementing both model A (FIG. 8) and model B (FIG. 9), the optimizer routine will both determine a collision-free solution while minimizing the likelihood that collisions appear post-tuning, for example, through the process of tuning imperfections and frequency spread due to junction drift and aging. The likelihood that collisions appear may be quantified using statistical methods, such as Monte Carlo yield modeling, whereby a set of frequency deviations of random amplitude (subject to a frequency spread parameter) may be applied to the qubit frequencies, and the resulting number of collisions calculated. By repeating this process a certain number of times, it is possible to determine the expectation value of the total number of collisions if a certain frequency spread is assumed. However, any other method of collision and/or yield assessment may be performed, as long as the output results in a yield metric reflecting the functional usability of the chip.

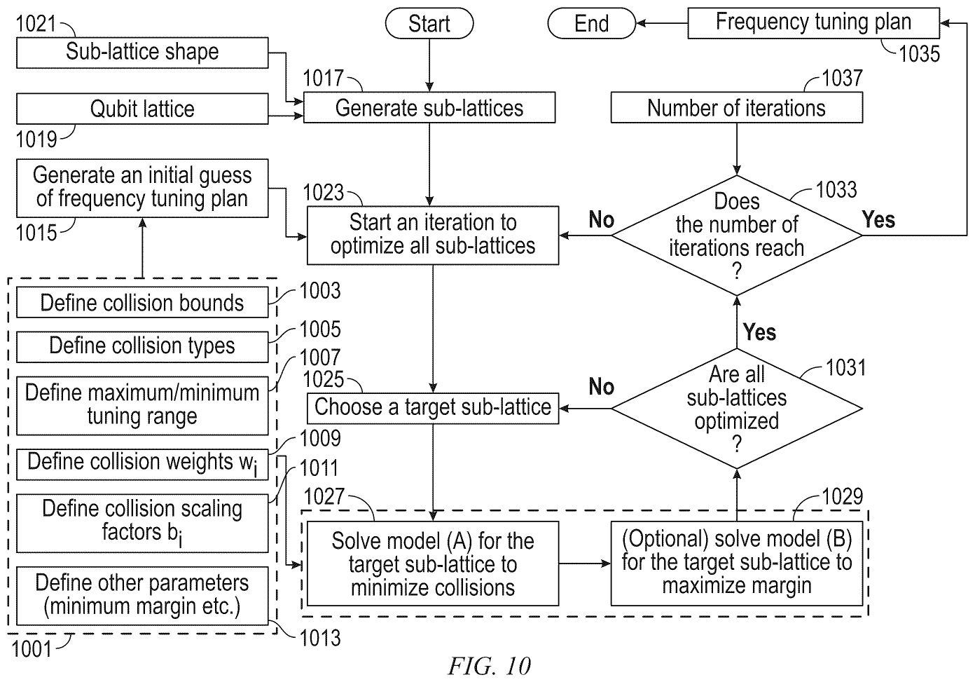

Furthermore in this regard, FIG. 10 shows an exemplary workflow of frequency tuning planning. In block 1001, define pertinent initial parameters, including collision bounds 1003, collision types 1005, maximum and minimum tuning ranges 1007, collision weights wᵢ 1009, collision scaling factors bᵢ 1011, and any other pertinent parameters 1013, such as minimum margin and the like. Based on the inputs, generate an initial guess for the frequency tuning plan in 1015. In step 1017, generate sub-lattices based on inputs including the qubit lattice 1019 and sub-lattice shape 1021. In step 1023, begin an optimization iteration to optimize all sub-lattices, based on the initial guess from step 1015 and the sub-lattices generated in step 1017. In step 1025, choose a target sub-lattice. In step 1027, solve model A (FIG. 8) for the target sub-lattice to minimize collisions, and optionally, in step 1029, solve model B (FIG. 9) for the target sub-lattice to maximize the margin from collision bounds. In decision block 1031, determine whether all sub-lattices have been optimized in the current optimization iteration. If not, logical flow proceeds back to step 1025. If yes, logical flow proceeds to decision block 1033. In decision block 1033, determine whether the number of optimization iterations has reached a maximum specified at 1037. If not, logical flow proceeds back to step 1023 and a new optimization iteration is started. If yes, logical flow proceeds to 1035 to output the frequency tuning plan for the LASIQ tuning process.

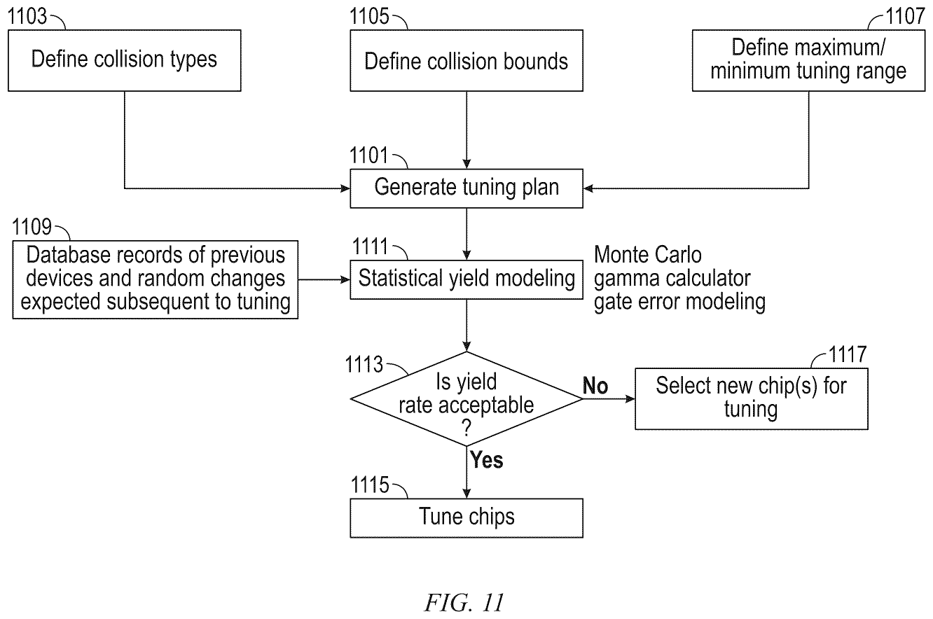

Turning now to FIG. 11, consider aspects of tuning plan generation. In one or more embodiments, a tuning plan is generated in step 1101, using an optimizer, and is based on tuning range constraints 1107, collision types 1103, and frequency collision bounds 1105 for each collision type. Yield modeling is performed in step 1111 (based on the tuning plan and database records 1109; e.g., Monte Carlo, Gamma calculator (i.e., the estimated overhead for probabilistic error cancellation as known from the IBM Research paper Ewout van den Berg et al., “Probabilistic error cancellation with sparse Pauli-Lindblad models on noisy quantum processors,” Nature Physics, 2023 May 8:1-6), Gate error modeling, and if determined to be acceptable in decision block 1113, the chip is tuned in step 1115; otherwise a new chip may be selected for tuning in step 1117. The database record 1109 may, for example, be related to historical frequency spreads, which may typically be around 20 MHz, that is, the precision to which qubit frequencies may be determined using room temperature junction resistance data is approximately 20 MHZ, where this spread contains contributions from the frequency prediction precision as well as junction aging prior to cooldown and measurement. Collision bounds could be, for example, 1% gate error or 0.5% gate error as shown in FIGS. 6 and 7. In one or more embodiments, in step 1107, define the maximum and minimum tuning range available for qubits that are going to be tuned; this can be obtained from calibration runs on sets of trial junctions with similar or identical characteristics to the junctions being tuned. Database records 1109 can be obtained from empirical observations of a number of devices that have been cooled to determine what type of frequency spreads can be anticipated; when fed into the statistical yield models 1111, it can be determined what at least some of the possible imperfections are. Database records 1109 can include, for example, statistics and measured outcomes of previous devices and random changes expected subsequent to tuning.

Note that Gamma is an expression of overhead for how many computer runs must be made/time of compute, and improves with corresponding improvements to qubit coherence and reduction in collisions. By reducing this runtime overhead, a greater number of qubits may be run with greater circuit depth, leading to the ability to implement deeper quantum circuits which may be used, for example, in the case of probabilistic error correction.

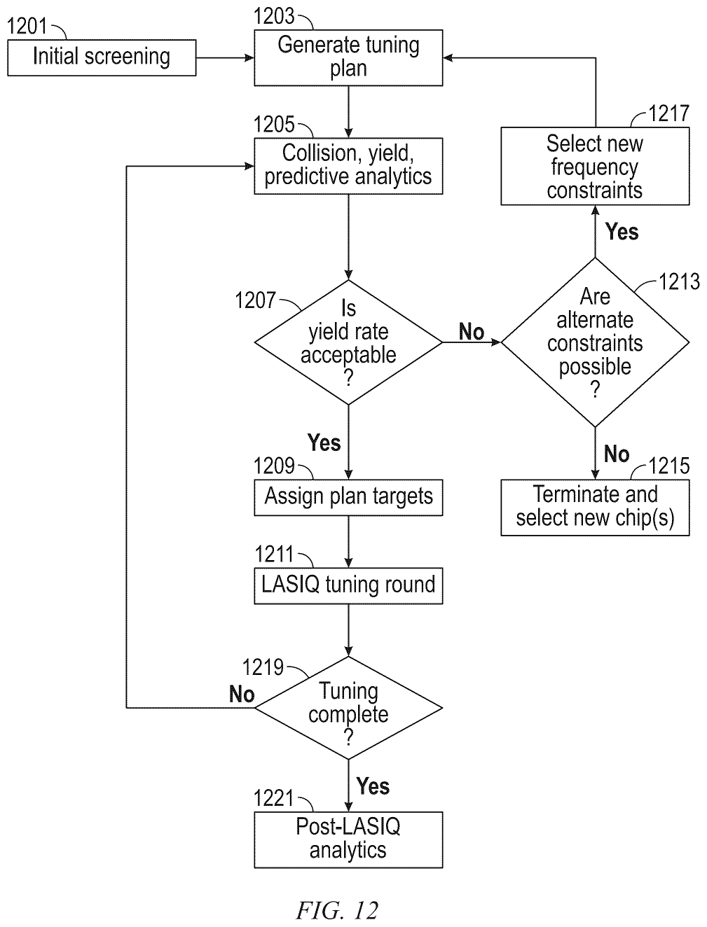

FIG. 12 shows an exemplary process of feedback for in-situ yield improvement by regenerating new tuning plans as the tuning progresses. Indeed, FIG. 12 shows aspects of feedback during tuning. In step 1201, carry out initial screening. In step 1203, generate a tuning plan. In step 1205, perform predictive yield analysis (e.g., Monte Carlo analysis) and collision analysis in-situ during LASIQ tuning. In decision block 1207, determine whether the yield rate is acceptable. If so (YES branch), assign the plan targets to the lattice in step 1209, and then proceed to LASIQ tuning in step 1211. On the other hand, if the yield rate is not acceptable (NO branch of decision block 1207), proceed to decision block 1213 and determine whether alternate constraints are possible. Alternate constraints may, for example, involve new acceptable collision-free bands of allowable frequencies for each qubit based on a new tuning plan. Alternate frequency constraints may also, for example, be based on the ability of the qubits to tune in a negative frequency direction, or bi-directionally. In such a case, new frequency tuning limits may be implemented on an existing set of qubits to allow for in situ correction of imperfections arising from overshoot or undershoot of qubit frequencies. We have found that the regenerated tuning plan will often be quite different than the original. In this sense, each chip at any given time may be considered to be an entirely new chip, merely with different boundary conditions from its previous rounds of tuning. If not (NO branch of block 1213), terminate the process and select new chip(s) for screening at 1215. If alternate frequency constraints are possible (YES branch), select the new frequency constraints in step 1217 and return to step 1203 to generate a new tuning plan. Predictive yield analytics 1205 is performed, and if it is satisfactory in decision block 1207, the new plan targets are assigned at 1209. After the LASIQ tuning in step 1211, determine in decision block 1219 whether tuning is complete. If not (NO branch), logical flow proceeds back to step 1205 to assess the quality of the tuning round. On the other hand, if tuning is complete (YES branch), proceed to post-LASIQ analytics in step 1221.

Thus, FIG. 12 relates to tuning plan generation and tuning flow. In one or more embodiments, each time a tuning plan is generated at 1203, run predictive analytics (e.g. Monte Carlo) at 1205. If the yield rate is not acceptable, constraints can be modified, e.g. increase the tuning range, or change collision weights/bounds. This process iterates until a good tuning plan is found, then a LASIQ tuning round is performed at 1211. After each round, the tuning is checked at 1207 to ensure the yield rate is still acceptable, otherwise the constraints may again be modified to generate a new tuning plan. In one or more embodiments, tune each qubit iteratively. One tuning round means tuning across all the qubits on the chip, in a round-robin format as defined previously. Possible alternate constraints include different collision boundaries, different frequency tuning limits, acceptable operating frequencies for qubits, or the like.

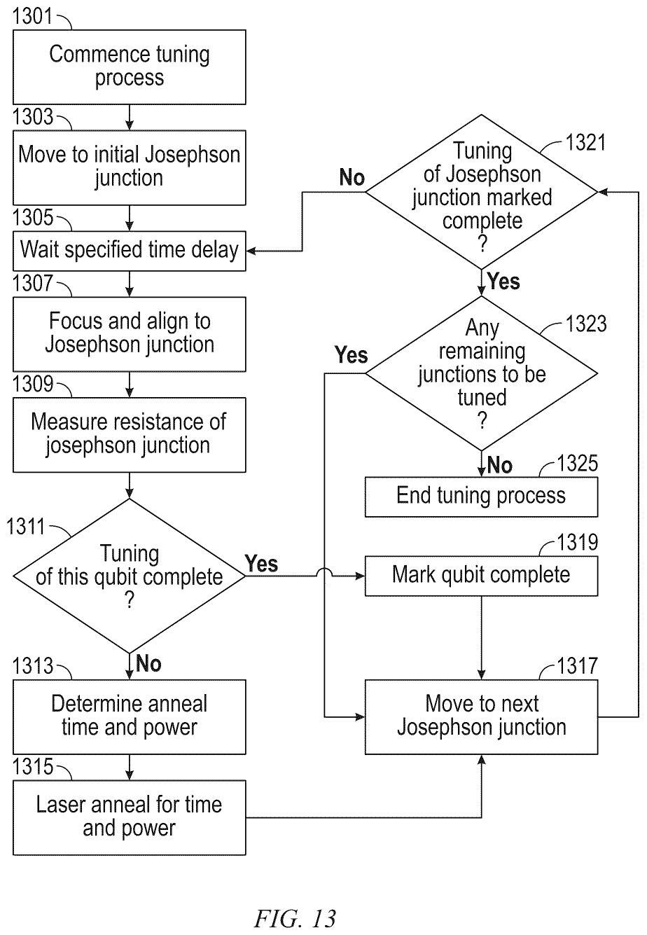

FIG. 13 depicts iterative tuning rounds. The tuning process is commenced in step 1301. In step 1303, move to the initial Josephson junction. In step 1305, wait a specified time delay. This time delay may, for example, be a fixed time delay or may be a variable time delay to allow time for the junctions to settle from the prior tuning round. In step 1307, focus and align to the Josephson junction. In step 1309, measure the resistance of the Josephson junction. In decision block 1311, determine whether tuning of the particular qubit is complete. If not, proceed to step 1313 and determine the anneal time and power. Then, in step 1315, carry out laser annealing for the appropriate time and power. In step 1317, move to the next Josephson junction. In decision block 1321, determine whether tuning of that junction has been marked complete. If not, logical flow proceeds to step 1305. If yes, logical flow proceeds to decision block 1323. If there are no more junctions remaining to be tuned, end the tuning process at 1325. If there are more junctions to be tuned, move to the next junction in step 1317. In decision block 1311, if tuning of the particular qubit is complete, mark the qubit as complete in step 1319, and move to the next junction in step 1317.

Thus, one or more embodiments carry out multiple tuning rounds until the tuning is deemed complete, using an iterative approach to resistance targets for each junction. A delay may be implemented to allow relaxation of resistances before the next annealing iteration on a qubit. With regard to measuring resistance of the Josephson junction at 1309 and determining whether the tuning of the qubit is complete in decision block 1311, in one or more embodiments, check how far the junction resistance is from the target resistance. If the tuning of the qubit is not complete, then the distance from the target can be used to determine the required anneal time and power at 1313.

The tuning process determines whether the currently measured junction resistance (denoted R_{current}) of the given Josephson junction is at or near a target junction resistance (denoted R_{target}) for the given Josephson junction in 1311. In some embodiments, the given Josephson junction will be deemed to be at its target junction resistance R_{target} when an absolute difference between the measured junction resistance R_{current} and the target junction resistance R_{target} is within some specified threshold percentage of the target junction resistance R_{target}, i.e.,

$$\frac{\vert {R}_{target} - {R}_{current} \vert}{{R}_{target}} \leq x .$$

In some embodiments, x=0.003 (or 0.3%). For example, assuming the given Josephson junction has a target junction resistance R_{target}=10K Ohms, the given Josephson junction will be deemed to be at its target junction resistance R_{target} when the measured junction resistance R_{current} is in a range of about 9,970 Ohms to about 10,030 Ohms (i.e., about +/−30 Ohms around R_{target}).

If it is determined that the measured junction resistance R_{current} of the given Josephson junction is not at or near the target junction resistance R_{target} for the given Josephson junction (negative determination in block 204), the tuning process proceeds to determine the anneal time and the laser power to utilize for laser annealing the given Josephson junction for the given iteration, based on the measured junction resistance in 1309. In particular, the tuning process will determine a remaining amount of resistance shift (denoted ΔR_{remaining}) needed to reach the target junction resistance R_{target} of the given Josephson junction based on the currently measured junction resistance R_{current}, where ΔR_{remaining}=R_{target}−R_{current}. The pulse time for the given laser anneal iteration at a given laser power level is determined based at least in part on a function of ΔR_{remaining} and a total amount of annealing time spent for previous “pulses” performed in previous tuning iterations of the given Josephson junction

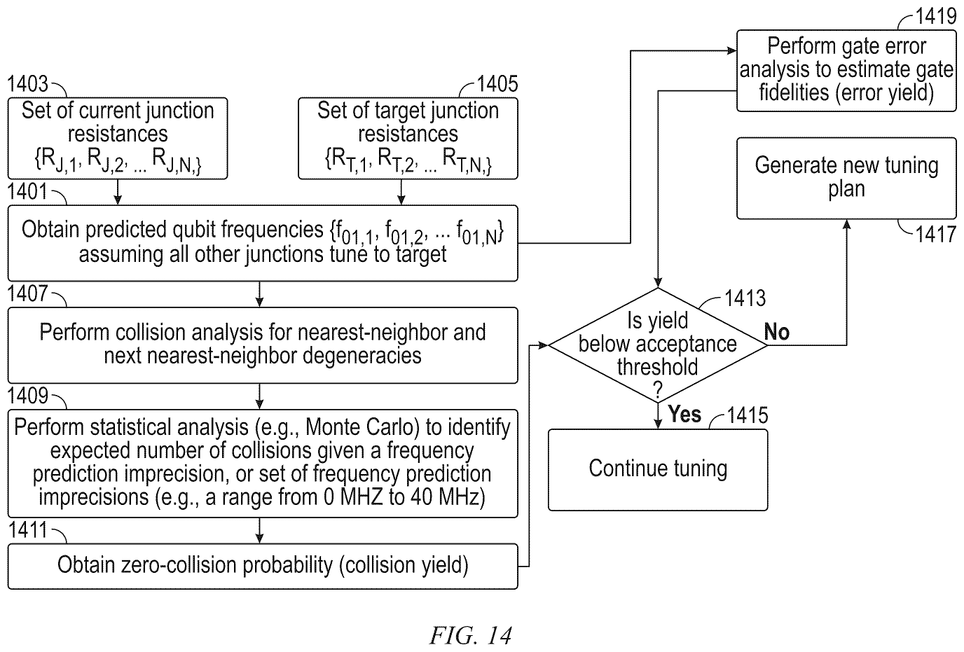

FIG. 14 depicts aspects of yield assessment. In step 1401, obtain predicted qubit frequencies {f_{01,1}, f_{01,2}, . . . f_{01,N}} assuming all other junctions tune to target, based on input 1403 (set of current junction resistances {R_{J,1}, R_{J,2}, . . . . R_{J,N},}) and 1405 (set of target junction resistances {R_{T,1}, R_{T,2}, . . . . R_{T,N},}). In step 1407, perform collision analysis for nearest-neighbor (NN) and next-nearest-neighbor (NNN) degeneracies. In step 1409, perform statistical analysis (e.g., Monte Carlo) to identify the expected number of collisions given a frequency prediction imprecision, or set of frequency prediction imprecisions (e.g., a range from 0 MHz to 40 MHz). In step 1411, obtain the zero-collision probability (collision yield). In decision block 1413, determine whether the yield is below an acceptance threshold. If yes, continue tuning at 1415; else, generate a new tuning plan in step 1417. Returning back to step 1401, in a parallel path to steps 1407-1411, in step 1419, perform gate error analysis to estimate gate fidelities (error yield).

Thus, advantageously, it is possible to quantify how well tuning is proceeding by quantifying collisions and zero-collision probability and gate fidelity and defining acceptance thresholds; in one or more embodiments, this can occur in situ while tuning. The yield assessment aspects of FIG. 14 relate to the collision, yield, predictive analytics block 1205 of FIG. 12, and also to the statistical yield modeling block 1111 (in one or more embodiments, blocks 1205 and 1111 are essentially the same). Collision analysis can be performed for the data in the tables such as 0.5% and 1% gate error bounds in FIGS. 6 and 7. In one or more embodiments, perform statistical analysis (e.g., Monte Carlo) in step 1409 to identify expected number of collisions given a frequency prediction imprecision (e.g., 20 MHz), or a set of frequency prediction imprecisions (e.g., a range from 0 MHz to 40 MHz of freq. spread). With regard to the step of generating a new tuning plan in 1417, if no new tuning plans are available, it is appropriate to pick a different chip. Yield assessment can be used on tuning plans or additionally performed in situ during the tuning. There are two alternative ways to go from step 1401 to decision block 1413. The branch 1407-1409-1411 in itself does not provide a gate fidelity number, but rather assesses the expected number collisions for a given spread and therefore quantifies the probability of obtaining high gate fidelities. The branch through step 1419 estimates actual gate fidelities based on gate-error models and may be similarly used to define an acceptance threshold for the tuned quantum processors.

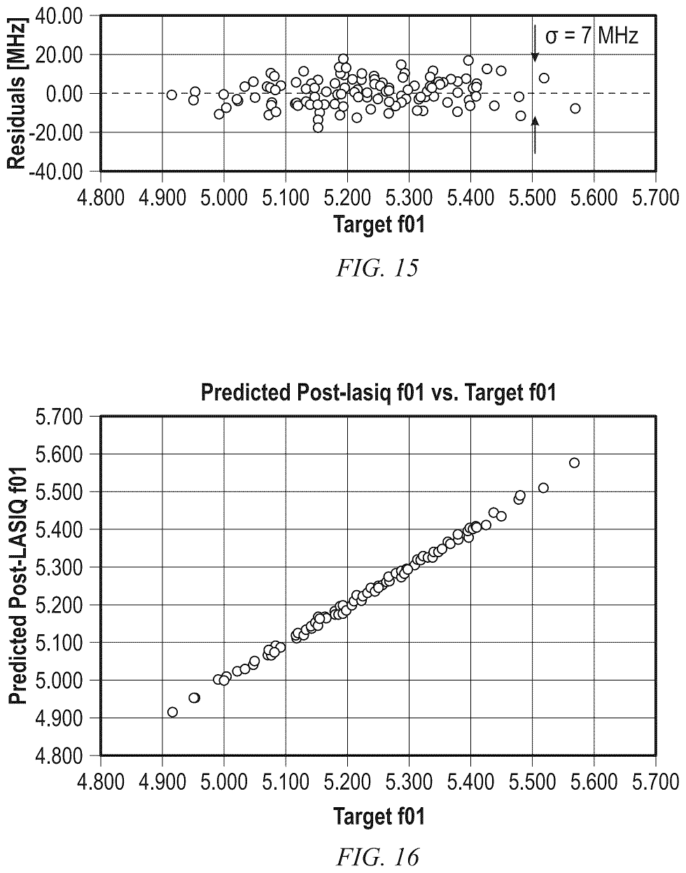

Referring now to FIGS. 15-18, consider exemplary LASIQ tuning to an optimized plan. This is an example of tuning to target frequencies. In the example, the tuning residual is 7 MHz, based on the deviation of the predicted frequencies to target frequencies. One or more embodiments use an iterative tuning method as discussed above to adaptively approach frequency targets. The data in FIGS. 15 and 16 is based on actual experimental data from an IBM Eagle chip, using above-discussed iterative method. In each case, the X axis is the desired target frequency. It can be seen that quite precise tuning is possible using the LASIQ tuning process. In FIG. 15, the residuals are shown on the Y axis, and correspond to the deviation of the final predicted frequency (post-LASIQ tuning) with respect to the desired target frequency. This residual corresponds to an equivalent frequency precision of 7 MHz. Such precision is estimated based on the resistance measurements. FIG. 16 shows the actual predicted post-LASIQ frequencies for with respect to the desired target for, demonstrating excellent linear correlation and is evidence of the efficacy of an exemplary LASIQ tuning process for frequency control, in accordance with aspects of the invention. In other words, by generating tuning plans using the objective functions and constraints outlined in FIGS. 8 and 9, the resulting frequency tuning plan may be successfully achieved through the LASIQ tuning process.

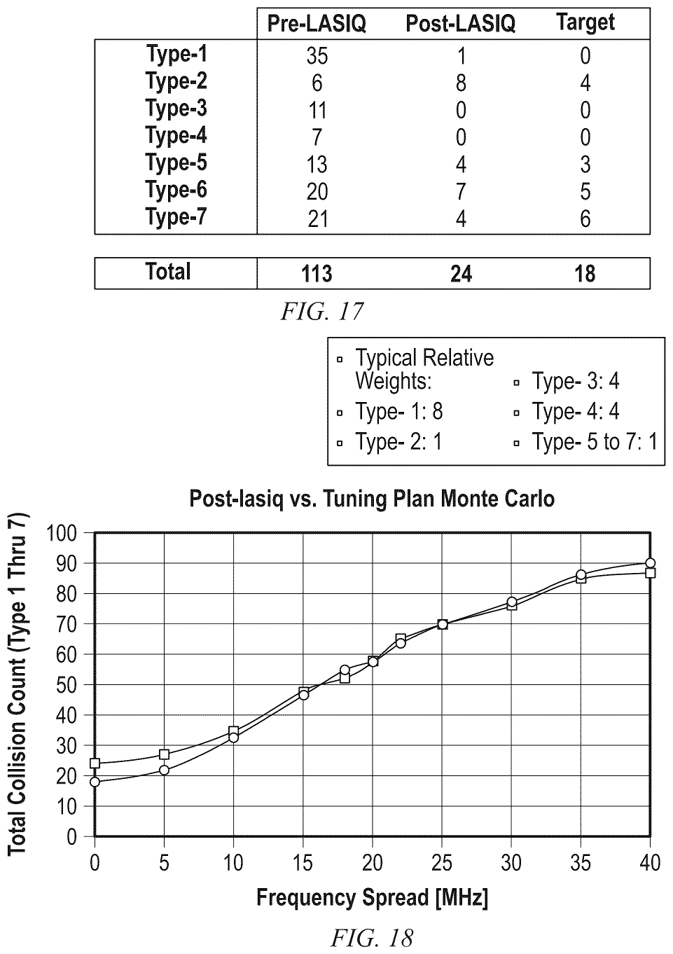

The table of FIG. 17 shows an as-tuned collision analysis (post-LASIQ), as compared with the target. It can be seen from FIG. 17, that the initial pre-LASIQ collisions are substantial, with 113 type-1 through 7 collisions. After the tuning plan is generated and the LASIQ tuning process is complete, the second column in FIG. 17 shows the significant reduction in total collisions, particularly type-1 collisions, which are of great detriment to two-qubit gate fidelity. In this specific example, model A (FIG. 8) was used in the frequency tuning plan, but model B (FIG. 9), although not used in this example due to residual remaining collisions, may be optionally used to further increase the margins from the collision bounds. In the third column of FIG. 17, the tuning plan collisions are shown, and it is apparent that the total post-LASIQ collision count is very similar to the target collision count, again demonstrating the efficacy of the LASIQ tuning process to achieve the desired tuning plan.

FIG. 18 shows the Monte Carlo analysis corresponding to the Eagle processor in FIG. 17 for a range of frequency spreads spanning from 0 MHz (i.e., perfect cryogenic frequency precision) to 40 MHz. Two curves are depicted in this example: the curve with round data points is the target, and the curve with square data points is the post-LASIQ result. Each point on the curve is a result of an average collision count by introducing a random spread corresponding to the value on the X axis. In this example, the post-LASIQ Monte Carlo is essentially identical to the tuning plan Monte Carlo, which indicates that tuning outcomes in accordance with one or more embodiments are as good as the tuning plan that is generated. The figures thus depict the effectiveness with which an exemplary embodiment can remove collisions and achieve a desired result. In the exemplary tuning plan, type-1, type-3, and type-4 are weighted the most, and type-2, type-5, type-6, and type-7 the least. In a non-limiting exemplary embodiment, typical relative weights wᵢ include Type-1:8, Type-2:1, Type-3:4, Type-4:4, and Type-5 to 7:1.

Thus, FIGS. 17 and 18 show pertinent metrics, corresponding to the Monte Carlo blocks 1111, 1409. FIG. 18 is a Monte Carlo analysis of both the target and resulting achieved frequencies (post LASIQ). It can be seen that the curves lie close to each other; the tuning is usually on par with the quality of the plan. The X axis is the frequency spread. When there is a greater frequency spread, the collision count is expected to increase. Consider that a plan has been generated, but there has not been quite perfect tuning to that plan, and there is some frequency spread and/or once the chip cools down, there is some frequency scrambling, which will result in a greater number of collisions. This type of curve is, effectively, a way to assess the yield; i.e., determine whether the total number of collisions is where it was expected to be. Considering again the relative weights, in one or more embodiments, there are two ways to control which collisions to are to be more strongly avoided. One is to control the weights wᵢ, which increases or decreases the relative importance of the particular collision type i. The other is to directly control the scaling factor of collision bound b₁, b₂, and so on—this expands the avoidance regime for each collision.

One or more embodiments provide a method including generating an optimized tuning plan for a quantum computing device based on an objective function and constraints, where the goal is to minimize collisions subject to collision types and bounds; and determining whether the yield rate is acceptable based on screening analytics, e.g. Monte Carlo or gate error modeling. Further, one or more embodiments provide a tuning plan optimizer including a sub-lattice tiling scheme whereby a tuning plan maybe generated rapidly; an objective function, with the goal of minimizing total collisions, or a subset of collisions; constraints, based on collision types, collision bounds, tuning range, collision weights; a collision weighting scheme that prioritizes collisions based on collision weights; and scaling factors to increase/decrease collision bounds by type.

One or more embodiments employ a tuning method including an iterative and adaptive method to accurately and precisely approach qubit frequency targets. One or more embodiments employ a tuning apparatus, including a laser tuning system and a processor to execute the tuning plan and screening analytics.

It is worth noting that, in FIG. 11, step 1101 is the result of FIG. 10 at 1035. FIG. 13 depicts the actual physical tuning process, which can be carried out with a LASIQ machine, for example. FIG. 14 shows one way to implement step 1111. In FIG. 10: 1005, elements 1009 and 1011 correspond to FIGS. 6 and 7; elements 1003, 1007, and 1013 include constraints that can be set by the skilled artisan, given the teachings herein, using heuristics or other techniques. Step 1015 can include selecting a lower or upper bound or random pick, as discussed elsewhere herein. Qubit lattice 1019 includes, for example, a data structure defining connectivity. Elements 1021 include, for example, the shapes such as from FIGS. 2-5. In 1017, the sublattices can be generated manually or using a deterministic stepping algorithm. Elements 1023, 1025 can include, for example, setting an index/counter. Elements 1027, 1029 can be implemented as per FIGS. 8 and 9. Element 1037 can include a limit on the number of iterations determined heuristically or as otherwise discussed herein; say, 2-10 in a non-limiting example. Blocks 1031, 1033 can be comparison statements in a high-level programming language. Element 1035 can be a data structure holding the tuning plan. FIG. 12 shows an exemplary process of feedback for in-situ yield improvement by regenerating new tuning plans as the tuning progresses, according to aspects of the invention; it could be used, for example, with tuning plans generated per FIG. 10. Generally, for any elements or steps not described in great detail, the same can be implemented by the skilled artisan by adapting known techniques implemented in software, given the teachings herein.

Regarding the initial screening in 1201, screening is used to ensure that all chip candidates allocated for tuning are of sufficient predicted post-tuning quality that they should be entered into the LASIQ tuning queue. Generation of a tuning plan in 1203 can be achieved using any variety of tuning plan generators that may be used to satisfy frequency constraints and achieve target gate fidelity. Such tuning plans include fixed-frequency patterns, fixed-frequency levels, optimizer solutions involving significant computational requirements, ad-hoc plans, or the like.

A pertinent input to the statistical analysis will be any random changes to be expected in qubit frequencies between the time of LASIQ tuning and the time of chip cooling and operation in a cryostat. These may be estimated from records of past devices as previously measured and stored in a database 1109 accessed by the statistical yield modeling algorithm 1111. Additionally, there is a material relaxation of the Josephson junction that occurs post-annealing, where junction resistances relax and stabilize to their final values, and this relaxation may be compensated and/or accommodated using an appropriate time delay between post-LASIQ and cryogenic frequency measurements, as per step 1305.

Further regarding tuning plan generators (optimizers) the IBM CPLEX optimizer (available from International Business Machines Corporation, Armonk, NY, USA) provides a software solution for linear programming optimization problems, which is broadly applicable to problems of the type described here (i.e., generating frequency tuning plans given frequency collision constraints). Other algorithms may, for example, attempt to optimize the utility of quantum processors by computing the longest possible collision-free chain, ring, or other such conformation given the constraints on tunability, collision bounds, and lattice geometry. Optimizers using randomized plan generators or ad-hoc generators can also be used, for example, in the case of Monte Carlo tuning plan generators whereby a large number of frequency patterns are attempted to sample the solution space. Other algorithms, such as algorithms for collision avoidance, may cycle through different topologies to incrementally shift qubit frequencies by parameterized amounts to find a collision-free (or collision-reduced) number of qubits in the chosen assessment topology until convergence or the greatest number of interconnected collision-free qubits within a computational time limit. Static optimizers using Monte Carlo tuning or simulated annealing might also be used.

Tuning success or completion of a junction may be determined by the proximity of a junction resistance to its target value. For example, a junction may be deemed ‘complete’ when the current junction resistance is measured to be within an acceptance threshold (e.g., 0.3%) of the target resistance. That is, if a target resistance is, for example, 10K Ohms, an acceptable success band may be defined to be +/−30 Ohms, or equivalently, a range from 9970 Ohms to 10030 Ohms. It is to be noted that the term ‘current junction resistance’ as used herein is meant to denote a junction resistance measured in the sense of occurring in or existing at a present time, or a most recently measured junction resistance.

A specific quantum computing-based device (e.g., a singulated die intended as a distinct quantum processor chip) may be deemed complete when all junctions are tuned satisfactorily (e.g., within 0.3%) of target resistances, and statistical yield models indicate that the expected likelihood of collisions or probability of zero-collision yield lies below an acceptance threshold. The overall quality of tuning, for example, may be assessed by observing a smooth and monotonic progression towards target resistances, starting from initial resistances. Note that it is also possible, for example, that upon a certain number of annealing rounds of LASIQ tuning for a given plan, that the yield rate will never be acceptable for the given plan. In a typical case, a maximum of 10 annealing rounds (for example) are therefore allowed for a given plan, as it has been typically and empirically the case that a larger number of iterations would indicate an inability of the tuning to converge to the desired target frequency plans. If the qubits do not reach target within this number of annealing rounds, the plan is deemed to be unapproachable and a new tuning plan is generated. In this case, the flow may also progress to block 329, and a new plan is generated. The number of acceptable annealing rounds may also be determined heuristically, based on the rate of progression towards targets as may be determined from historical tuning progressions, and/or calibration tuning rates on trial junctions. Generally, see decision block 1033.

Yield can be understood to include at least two principal elements. The first is tuning yield, which is a measure of the precision and/or accuracy of laser tuning of the Josephson junctions. The second is functional yield, which is a measure of the number of collisions of the tuned multi-qubit lattice, zero-collision probability, gate error yield (i.e., average gate error and gate fidelity), and the like. In general, the process of screening, which involves generating a tuning plan and assessing the quality of the tuning plan, relies on the assumption of perfect tuning yield. That is, all qubits successfully attain their targets after laser annealing. However, imperfect tuning yield will impact functional yield in the sense that qubits are no longer able to attain their target frequencies in all cases, which may impact the assessment of collisions, zero-collision probability, gate errors and the like.

It will accordingly be appreciated that one or more embodiments advantageously improve tuning precision in an adaptive tuning process, but which tuning imperfections may be compensated by determining alternate frequency constraints such that a new or modified tuning plan may be generated based on these alternate frequency constraints, and therefore increase the overall tuning precision and success rate.

In one or more embodiments, all structures are made of superconducting materials on a dielectric substrate and all structures contain Josephson junctions whose tunnel-barrier is susceptible to tuning by laser-annealing. Structures may include qubits of various kinds, or SQUIDs (superconducting quantum interference devices), or single Josephson junctions, or other combinations of Josephson junctions, capacitors and inductors. They may be galvanically, inductively, or capacitively linked with neighboring structures on-chip. A qubit chip may additionally incorporate functional structures which are not qubits but which contain Josephson junctions that may be of different design and construction as compared to the qubits. A modular quantum processor design may further incorporate quantum coupling structures whose Josephson junctions are of different design or construction as compared to the Josephson junctions in the qubits and other functional structures. The several types of Josephson junctions typically undergo calibration to determine their response to laser-power and exposure time. These separate calibrations determine the tuning range specific to each type of qubit or other structure.

### Recapitulation

Given the discussion thus far, and referring, for example, to FIG. 10, it will be appreciated that, in general terms, an exemplary method, according to an aspect of the invention, includes the step of defining a plurality of qubit collision types 1005 and a plurality of constraints (generally, 1001). A further step 1027 includes, for a group of qubits, using a computerized mixed-integer programming solver to, subject to the constraints, iteratively minimize collisions by minimizing a sum of products of weights multiplied by an amount of frequency collisions for given ones of the constraints of each one of the collision types. Refer to the definition of “optimization iteration” above. A still further step includes outputting a frequency tuning plan 1035 for the group of qubits, based on the iterative minimization. An even further step includes carrying out or otherwise facilitating tuning physical qubits in accordance with the frequency tuning plan, as per FIG. 13.

In one or more embodiments, the tuning includes LASIQ (Laser Annealing of Stochastically Impaired Qubits) tuning.

One or more embodiments further include carrying out statistical modeling to assess yield associated with the frequency tuning plan; in this aspect, the LASIQ (Laser Annealing of Stochastically Impaired Qubits) tuning is carried out responsive to the statistical modeling indicating acceptable yield. Refer to FIG. 11 blocks 1111 and 1113 YES branch to 1115.

Referring to block 1029 in FIG. 10, one or more embodiments further include, following the iterative minimization of collisions, for the group of qubits, using the computerized mixed-integer programming solver to iteratively maximize frequency margin, subject to the constraints.

Some such embodiments further include determining that a solution to the iterative minimization includes at least one collision; in this case, the iterative maximization of the frequency margin is carried out responsive to such determining.

As noted above, one or more embodiments make use of sublattices. Thus, one or more embodiments further include, as per block 1019, accessing a specification of a qubit lattice; as per block 1021, selecting at least one sublattice shape; and, as per block 1017, generating sublattices, in accordance with the at least one sublattice shape, such that each individual qubit in the qubit lattice is covered by at least one of the sublattices. In this aspect, the group of qubits mentioned above correspond to one of the sublattices.

One or more embodiments then iterate through all the sublattices in accordance with decision block 1031; thus, one or more embodiments further include repeating the step of iteratively minimizing collisions by minimizing the sum of products of weights multiplied by the amount of frequency collisions for given ones of the constraints of each one of the collision types, for additional groups of qubits corresponding to remaining ones of the sublattices.

In one or more embodiments, selecting the at least one sublattice shape includes selecting at least one of a nine qubit H-shape, an eleven qubit H-shape, a twelve qubit cycle shape, and a shape including each qubit and its neighboring qubits, as per FIGS. 2-5.

In one or more embodiments, the iterative minimization includes applying scaling factors to increase or decrease collision bounds by type; for example, apply bᵢ as discussed elsewhere herein.

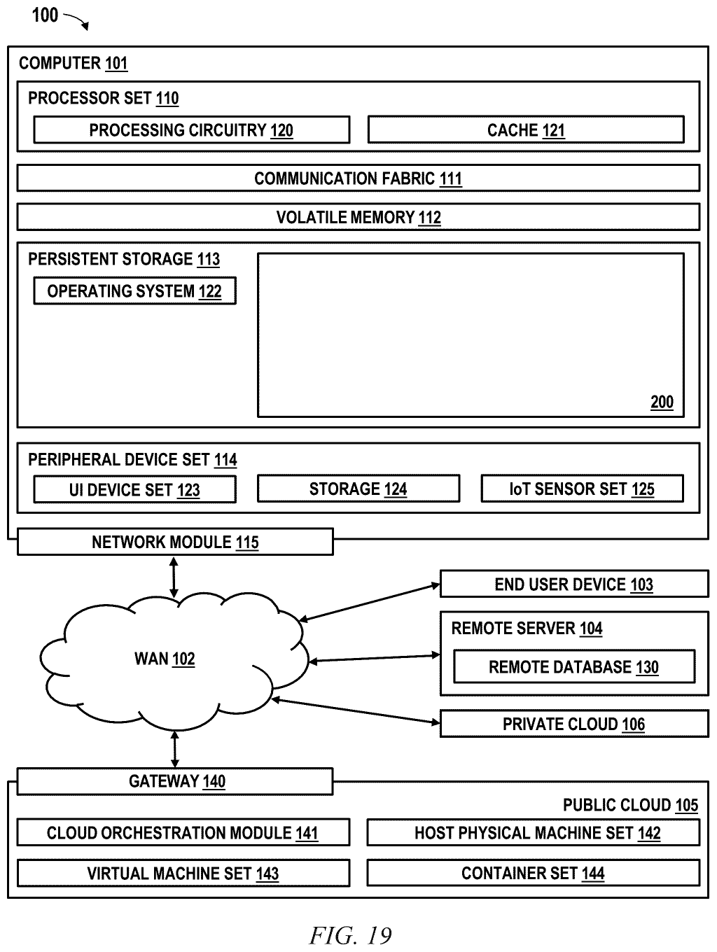

In another aspect (refer, e.g., to discussion of FIG. 19), a computer program product includes a computer readable storage medium having program instructions embodied therewith. The program instructions are executable by a processor such as 110 to cause the processor to perform any one, some, or all of the method steps herein.

The skilled artisan will appreciate that LASIQ tuning is a physical process, wherein a computer-controlled machine is making physical changes to the Josephson junction. When complete, the end result is a quantum computing device configured and tuned in accordance with techniques disclosed herein, which can be deployed and can carry out quantum calculations. The way in which yield is characterized advantageously ties into usability-good yield metrics are a direct measure of the usability of the quantum processor for quantum computations. Thus, the step of facilitating tuning physical qubits in accordance with the frequency tuning plan can include sending instructions to a LASIQ machine to tune a chip in accordance with the tuning plan. Such a tuned chip can then be deployed and used for computing. As noted below, end user device 103 could also include all or part (e.g., a controller) of a LASIQ tuning machine (controller, laser, mounting stage to hold chips, etc.), and such a machine could be coupled to computer 101 by WAN 102 or other network (e.g., local area network (WAN), wireless connection, direct cable connection, etc.). The skilled artisan will be familiar with LASIQ tuning machines per se, and, given the teachings herein, can utilize a LASIQ tuning machine to implement a tuning plan in accordance with aspects of the invention.

Refer now to FIG. 19, it being understood that techniques disclosed herein include, for example, computer-aided design of a quantum computer, wherein the aspects of the design process can be implemented on any kind of computer, quantum or conventional.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Refer now to FIG. 19. Note that end user device 103 discussed below could also include all or part (e.g., a controller) of a LASIQ tuning machine (controller, laser, mounting stage to hold chips, etc.), and such a machine could be coupled to computer 101 by WAN 102 or other network (e.g., local area network (WAN), wireless connection, direct cable connection, etc.).

Computing environment 100 contains an example of an environment for the execution of at least some of the computer code involved in performing the inventive methods, as seen at 200 (e.g., code for optimization to mitigate frequency crowding in multi-qubit processors). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 19. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 19 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
defining a plurality of qubit collision types and a plurality of constraints;
for a group of qubits, using a computerized mixed-integer programming solver to, subject to the constraints, iteratively minimize collisions by minimizing a sum of products of weights multiplied by an amount of frequency collisions for given ones of the constraints of each one of the collision types;
outputting a frequency tuning plan for the group of qubits, based on the iterative minimization; and
facilitating tuning physical qubits in accordance with the frequency tuning plan.

2. The method of claim 1, wherein the tuning comprises LASIQ (Laser Annealing of Stochastically Impaired Qubits) tuning.

3. The method of claim 2, further comprising carrying out statistical modeling to assess yield associated with the frequency tuning plan, wherein the LASIQ (Laser Annealing of Stochastically Impaired Qubits) is carried out responsive to the statistical modeling indicating acceptable yield.

4. The method of claim 1, further comprising, following the iterative minimization of collisions, for the group of qubits, using the computerized mixed-integer programming solver to iteratively maximize frequency margin, subject to the constraints.

5. The method of claim 4, further comprising determining that a solution to the iterative minimization includes at least one collision, wherein the iterative maximization of the frequency margin is carried out responsive to the determining.

6. The method of claim 1, further comprising:
accessing a specification of a qubit lattice;
selecting at least one sublattice shape;
generating sublattices, in accordance with the at least one sublattice shape, such that each individual qubit in the qubit lattice is covered by at least one of the sublattices;
wherein the group of qubits comprises one of the sublattices.

7. The method of claim 6, further comprising repeating the step of iteratively minimizing collisions by minimizing the sum of products of weights multiplied by the amount of frequency collisions for given ones of the constraints of each one of the collision types, for additional groups of qubits corresponding to remaining ones of the sublattices.

8. The method of claim 7, wherein selecting the at least one sublattice shape comprises selecting at least one of a nine qubit H-shape, an eleven qubit H-shape, a twelve qubit cycle shape, and a shape including each qubit and its neighboring qubits.

9. The method of claim 1, wherein the iterative minimization includes applying scaling factors to increase or decrease collision bounds by type.

10. A computer program product comprising a computer readable storage medium having program instructions embodied therewith, the program instructions executable by a processor to cause the processor to perform a method comprising:
defining a plurality of qubit collision types and a plurality of constraints;
for a group of qubits, using a computerized mixed-integer programming solver to, subject to the constraints, iteratively minimize collisions by minimizing a sum of products of weights multiplied by an amount of frequency collisions for given ones of the constraints of each one of the collision types;
outputting a frequency tuning plan for the group of qubits, based on the iterative minimization; and
facilitating tuning physical qubits in accordance with the frequency tuning plan.

11. The computer program product of claim 10, wherein the method performed by the processor further comprises, following the iterative minimization of collisions, for the group of qubits, using the computerized mixed-integer programming solver to iteratively maximize frequency margin, subject to the constraints.

12. A system comprising:
a memory; and
at least one processor, coupled to said memory, and operative to:
define a plurality of qubit collision types and a plurality of constraints;
for a group of qubits, use a computerized mixed-integer programming solver to, subject to the constraints, iteratively minimize collisions by minimizing a sum of products of weights multiplied by an amount of frequency collisions for given ones of the constraints of each one of the collision types;
output a frequency tuning plan for the group of qubits, based on the iterative minimization; and
facilitate tuning physical qubits in accordance with the frequency tuning plan.

13. The system of claim 12, wherein the tuning comprises LASIQ (Laser Annealing of Stochastically Impaired Qubits) tuning.

14. The system of claim 13, wherein the at least one processor is further operative to carry out statistical modeling to assess yield associated with the frequency tuning plan, wherein the LASIQ (Laser Annealing of Stochastically Impaired Qubits) is carried out responsive to the statistical modeling indicating acceptable yield.

15. The system of claim 12, wherein the at least one processor is further operative to, following the iterative minimization of collisions, for the group of qubits, use the computerized mixed-integer programming solver to iteratively maximize frequency margin, subject to the constraints.

16. The system of claim 15, wherein the at least one processor is further operative to determine that a solution to the iterative minimization includes at least one collision, wherein the iterative maximization of the frequency margin is carried out responsive to the determining.

17. The system of claim 12, wherein the at least one processor is further operative to:
access a specification of a qubit lattice;
select at least one sublattice shape;
generate sublattices, in accordance with the at least one sublattice shape, such that each individual qubit in the qubit lattice is covered by at least one of the sublattices;
wherein the group of qubits comprises one of the sublattices.

18. The system of claim 17, wherein the at least one processor is further operative to repeat the step of iteratively minimizing collisions by minimizing the sum of products of weights multiplied by the amount of frequency collisions for given ones of the constraints of each one of the collision types, for additional groups of qubits corresponding to remaining ones of the sublattices.

18. The system of claim 18, wherein selecting the at least one sublattice shape comprises selecting at least one of a nine qubit H-shape, an eleven qubit H-shape, a twelve qubit cycle shape, and a shape including each qubit and its neighboring qubits.

20. The system of claim 12, wherein the iterative minimization includes applying scaling factors to increase or decrease collision bounds by type.
